(19) United States
(12) Patent Application Publication
(10) Pub. No.: US 2020/0011288 A1
(43) Pub. Date: Jan. 9, 2020

(54) TURBINE SYSTEM FOR PRODUCING ELECTRICAL ENERGY AND METHOD THEREFOR

(71) Applicant: Netta WEINROTH, Moshav Hodaya (IL)

(72) Inventor: Netta WEINROTH, Moshav Hodaya (IL)

(21) Appl. No.: 16/491,099

(22) PCT Filed: Mar. 4, 2018
(86) PCT No.: PCT/IL2018/050242

§ 371 Date: Sep. 4, 2019

(30) Foreign Application Priority Data
Mar. 6, 2017 (IL) 250954

(51) Int. Cl. F03B 13/26; F03B 13/22; F03B 3/12

(52) U.S. Cl. CPC F03B 13/26; H02K 7/18; F03B 3/12; F03B 13/22

(57) ABSTRACT

A system for producing electrical energy by converting the kinetic energy of fluids, comprising: a floatable base unit, a turbine system with its outer components positioned on top of said base unit, one or more barriers that are pivotally connected to said base unit, and barrier restricting elements that are located on top of said base unit and are suitable to restrict the rotation of said barriers around said pivot; wherein said barriers are located at a location around said turbine thereby permitting or blocking fluid from reaching the blades of said turbine, and wherein said barriers come into contact with said restricting elements as a result of a force applied on them by a fluid flow, and wherein the resulting position of the barriers prevents a counterflow effect on said turbine.

### FIELD OF THE INVENTION

The present invention relates to the field of renewable energy. More particularly, the invention relates to a system and method for producing electrical energy by converting the kinetic energy of fluids.

### BACKGROUND OF THE INVENTION

The kinetic energy of fluids can be converted into other forms of energy. One method comprises using a turbine, which produces electricity by converting the kinetic energy of the fluid with which it comes in contact into a rotational movement. The turbine blades are attached to a shaft that rotates along with the blades, and is coupled to an electric energy generator, such as a dynamo or, in another illustrative example the shaft itself is made of a conductive material and is surrounded by a magnetic field, so it produces electricity.

The performance of turbines is very much dependent on environmental conditions. More particularly, it depends on the momentum on the blades of the turbine that is obtained as a result of the contact with flowing fluids. The flow direction in relation to the position of a blade will determine the direction of the rotation. Of course, when there is more than one contact point of a fluid with the blades of a turbine, the simultaneous contact can be beneficial to the maximum only as long as the momentum in every point causes a rotation of the blades in the same direction. Counterflowing streams cause contrasting directions of rotation of the blades and will be referred to hereinafter as “counterflowing streams”.

Some turbine systems comprise elements suitable to direct fluids toward desired areas of the systems. Some of these systems require a structure around the turbine that forces a certain flow direction, regardless of the natural direction of the fluid, which of course can decrease the speed of the fluid, and thus results in a reduced momentum on the blades that come in contact with said fluid. There are also different types of elements that can influence flow directions, but the art has so far failed to provide an efficient system that prevents conterflowing streams in a turbine system, which is an object of the invention.

It is another object of the invention to provide a floating water turbine system. This turbine system obviates the many disadvantages of the prior art, not least the substantial installation costs.

Other objects and advantages of this invention will become apparent as the description proceeds.

### SUMMARY OF THE INVENTION

The present invention relates to a system for producing electrical energy by converting the kinetic energy of fluids, comprising: a floatable base unit, a turbine system with its outer components positioned on top of the base unit (wherein the outer components can be, for example, the blades of the turbine, or part of its shaft, or any other component of the turbine that is located above the surface of the base unit), one or more barriers that are pivotally connected to the base unit, and barrier restricting elements that are located on top of the base unit and are suitable to restrict the rotation of the barriers around the pivot.

The barriers are located at a location around the turbine (near or far), thereby permitting or blocking fluid from reaching the blades of the turbine, depending on their position that changes according to the direction of the flow. The barriers come into contact with the restricting elements as a result of a force applied on them by a fluid flow, and the resulting position of the barriers permits or blocks fluid from reaching the blades of the turbine, and prevents a counterflow effect on the turbine.

According to another embodiment of the present invention, the system further comprises a fin, which is connected to the bottom surface of the floatable base unit. The fin can also comprise an inner space, suitable to contain inner components of the turbine. The fin can also be detachable from the base unit.

According to another embodiment of the present invention, the system further comprises at least one net, located on top of the base unit, suitable to prevent different objects from reaching the base unit and to the components that are positioned on top of it, such as the blades of the turbine.

According to another embodiment of the present invention, the system further comprises walls, shaped to define the flow directions of fluids across the base unit. The walls can be positioned, for example, on parallel sides of the base unit, thus causing the fluid to flow between them, across the base unit and through the blades of the turbine. The walls can also be shaped and/or positioned differently in such a way that causes the fluid to increase its flow rate at a certain location, according to Bernoulli's principle, such as near the turbine.

According to another embodiment of the present invention, the system further comprises electricity conduction equipment, suitable to conduct the produced electricity from the turbine to desired targets, such as a capacitor, an engine of a vessel, or any other electricity consuming devices, and provide at least some of the electricity necessary for operating such devices.

The present invention also relates to a method for producing electrical energy by converting the kinetic energy of fluids, which comprises:
1) providing a floatable base unit, comprising:
   a. providing a turbine system;
   b. providing one or more barriers;
   c. pivotally connecting said barriers to said base unit;
   d. providing barrier restricting elements;
   e. positioning said restricting elements on top of said base unit, at a location suitable to restrict the rotation of said barriers around said pivot and prevent a counterflow effect on said turbine; and
2) placing said floatable base unit in a location exposed to fluid flow, thereby generating electrical energy in said turbine system.

### BRIEF DESCRIPTION OF THE DRAWINGS

In the drawings:

FIG. 1 is a schematic perspective view of the system, according to one embodiment of the invention;

FIGS. 2A and 2B are top views of the system of FIG. 1, showing the change in the position of the barriers as a result of a flow that comes from the left side; and

FIGS. 3A and 3B are top views of the system of FIG. 1, showing the change in the position of the barriers as a result of a flow that comes from the right side.

### DETAILED DESCRIPTION OF THE INVENTION

The present invention relates to a turbine system and method for producing electrical energy by converting the kinetic energy of fluids. Although the description refers mostly to water and sea waves as the fluid that propels the turbine, it is obvious that the invention also includes the use of other fluids as well. The system comprises a turbine and barriers, which are suitable to deflect the flow of fluids away from undesired parts of the turbine and allow direct flow of fluids toward other desired parts the turbine. The system also comprises a floatable base unit that supports barriers and a turbine, such that the blades are placed on top thereof.

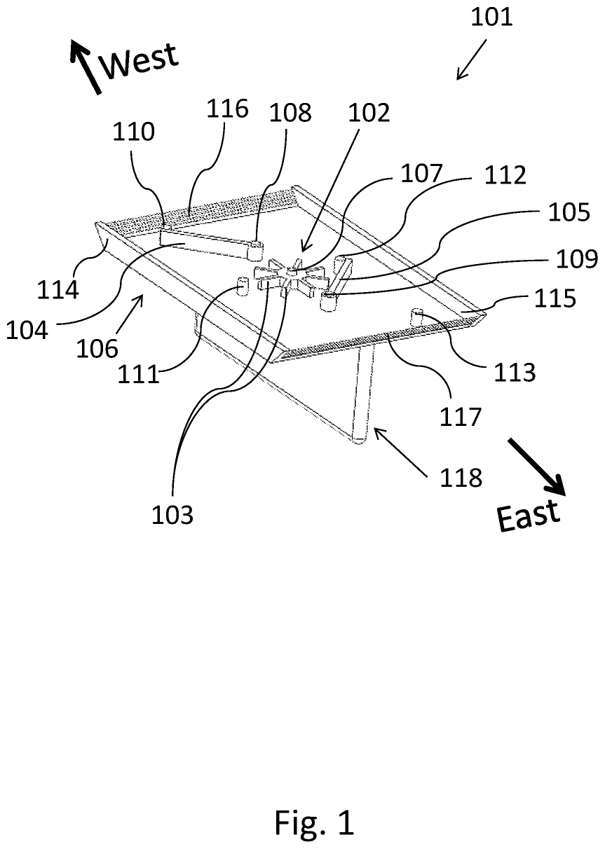

FIG. 1 is a perspective view of a turbine system 101, according to one embodiment of the invention. For the sake of clarity, one end of system 101, which is located at the top left side, is marked by “west”, and the other end, which is located at the bottom right side, is marked by “east”. Turbine 102 comprises a plurality of blades 103. For the sake of brevity, turbine 102 is not describe in detail since it is clear to any person skilled in the art how the rotation of blades 103 of turbine 102 can be used to produce electricity. In addition, the invention is not limited to a specific type of turbines, and turbine 102 can be replaced with any other device that is suitable to utilize the flow of different fluids in order to produce energy.

As shown in FIG. 1, system 101 also comprises barriers 104 and 105 that are placed in proximity to turbine 102. Turbine 102 and barriers 104 and 105 are connected to a base unit 106 by pins 107-109, but the connection between turbine 102 and base unit 106 and also between barriers 104 and 105 and base unit 106 can be performed by any mechanical means, as long as they don't interfere with the operation of turbine 102 and system 101 and allow the rotation of turbine 102 and barriers 104 and 105.

Pins 108 and 109 are also used each as a pivot for barriers 104 and 105. The rotational movement of barriers 104 and 105 is created as a result of the contact with fluids, since a flow (or any force) that hits a certain point that is located at a distance from a rotational axis creates a torque. System 101 also comprises restricting elements 110-113 that are connected to base unit 106 and perform as stoppers for barriers 104 and 105. As will be further described in detail, barriers 104 and 105 and restricting elements 110-113 prevent the effect of counterflowing streams on turbine 102.

Base unit 106 comprises walls 114 and 115 that help define the flow directions of fluids across base unit 106, so that a fluid would flow from east to west or vice versa. The walls can also be shaped and/or positioned differently in such a way that causes the fluid to increase its flow rate at a certain location, for example, the space between the walls can be smaller at proximity to the turbine, so that the fluid will come in contact with the blades of the turbine at an increased speed. Base unit 106 also comprises nets 116 and 117 that are located at the western and eastern ends of base unit 106. Nets 116 and 117 are provided to prevent different objects from reaching base unit 106 so they do not interfere with the operation of any element of system 101, such as turbine 102, barriers 104 and 105, or restricting elements 110-113.

According to the embodiment of FIG. 1, the bottom surface of base unit 106 is connected to a fin 118 that is suitable to align base unit 106 with the flow direction and can also be used to stabilize base unit 106 when it is placed on a fluid surface, for example, when system 101 is used at sea for producing energy from sea waves. According to this embodiment of the invention, base unit 106 is designed to float slightly below water surface and keep turbine 102 and barriers 104 and 105 essentially at water surface, i.e. partially above water surface.

According to another embodiment of the invention, fin 118 is suitable to contain the inner components of turbine 102, such as a rotor or any components that are used for providing the flow of the electric current toward a desired location, and fin 118 can also be replaced with other elements that are suitable to contain the inner components of turbine 102.

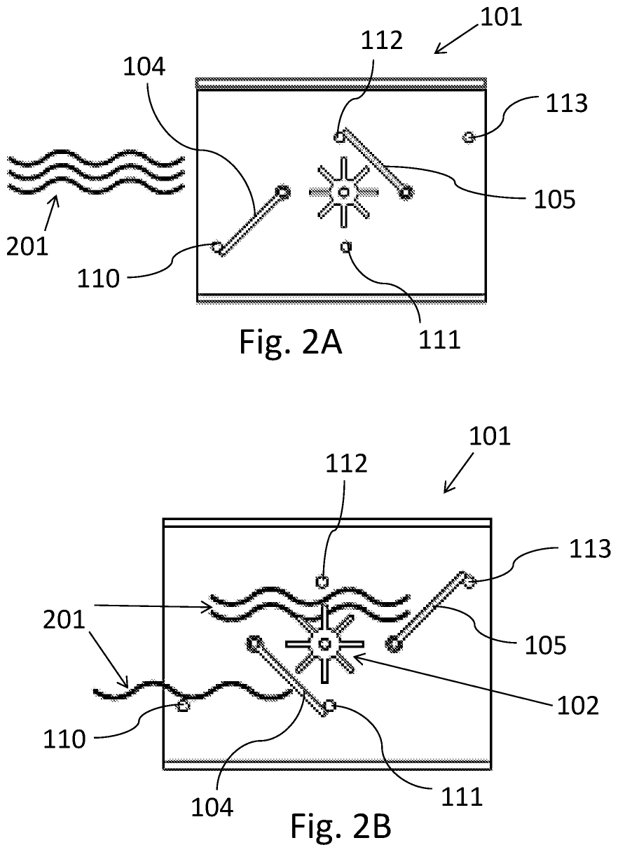

One object of the invention is to prevent counterflowing streams to impinge on blades 103 of turbine 102 since if a stream causes a rotation in a certain direction, the appearance of a counterflowing stream would cause a loss of kinetic energy that could have been utilized from the first stream. A second stream can be beneficial if it contributes to the rotation of a turbine in the same direction of the rotation that is created as a result of the first stream. FIGS. 2A-B and 3A-B illustrate how the elements of the invention prevent counterflowing streams to reach the turbine blades and thus maximize the efficiency of turbines.

FIG. 2A is a top view of system 101 of FIG. 1, where barrier 104 is in contact with restricting element 110 and barrier 105 is in contact with restricting element 112. FIG. 2A also shows a stream 201 that approaches system 101 from the left side. FIG. 2B shows the result of stream 201 flowing through system 101 from the left side to the right side. When barrier 105 is pushed by stream 201 from the left side to the right side it rotates until it comes in contact with restricting element 113, thus allowing stream 201 to come in contact with turbine 102 and rotate it clockwise. When barrier 104 is pushed by stream 201 from the left side to the right side it rotates until it comes in contact with restricting element 111, thus preventing the negative effect of counterflowing streams by blocking stream 201 from rotating turbine 102 counterclockwise.

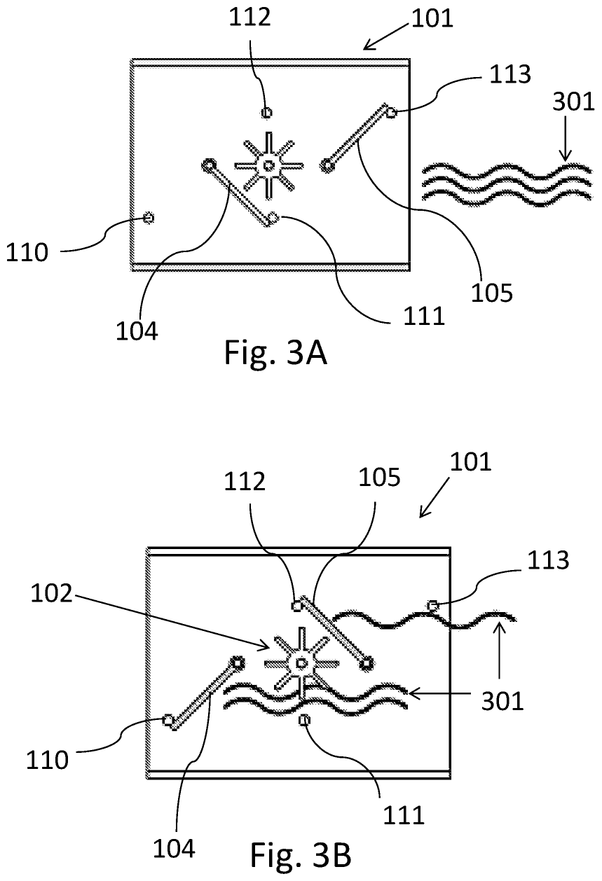

FIGS. 3A and 3B are similar to FIGS. 2A and 2B, illustrating how the system operates when a stream comes from the other direction. FIG. 3A is a top view of system 101 of FIG. 1, where barrier 104 is in contact with restricting element 111 and barrier 105 is in contact with restricting element 113. FIG. 3A also shows a stream 301 that approaches system 101 from the right side. FIG. 3B shows the result of stream 301 flowing through system 101 from the right side to the left side. When barrier 104 is pushed by stream 301 from the right side to the left side it rotates until it comes in contact with restricting element 110, thus allowing stream 301 to come in contact with turbine 102 and rotate it clockwise. When barrier 105 is pushed by stream 301 from the right side to the left side it rotates until it comes in contact with restricting element 112, thus preventing the negative effect of counterflowing streams by blocking stream 301 from rotating turbine 102 counterclockwise.

The system is not restricted to any number of barriers, and it can comprise one or more barriers. In addition, one barrier, for example, can be replaced with a stationary object or structure, like a wall, while other barriers are placed accordingly to prevent counterflowing streams in consideration of the proximity and shape of the stationary object and the flow that is created as a result.

System 101 can be attached to a vessel, such as a boat, in order to provide electrical energy to said vessel. When a vessel that comprises a system such as system 101 floats or sails, it can utilize the energy that is created by the system of the invention. When attached to a vessel, system 101 further comprises elements suitable to transfer electrical energy to the vessel. According to another embodiment of the invention, fin 118 is detachable from base unit 106 so that system 101 can be easily stored, for instance, during a storm when the efficiency of system 101 is relatively low and it is at risk of being damaged. It is noted that the system of the invention does not have to be attached to a vessel, and it can also be attached to other objects. The system can also comprise a capacitor and float independently, and in such a case it can be connected to shore, for example by a rope, or to other surrounding objects.

The embodiment of the figures shows only two barriers and four restricting elements, but it is noted that the invention is not limited to a specific number of barriers or restricting elements.

1. A system for producing electrical energy by converting the kinetic energy of a flowing liquid, comprising:
a. an open-structured floatable base unit configured with opposite inlet and outlet ends defining a flow path therebetween along which the liquid surrounding said base unit is able to flow after being introduced into said inlet end, and with opposite first and second walls extending between said inlet and outlet ends, for confining the flowing liquid therebetween;
b. a turbine system with its outer components positioned on top of said base unit, wherein said floatable base unit is adapted to keep a turbine of said turbine system at a level coinciding with an upper surface of the liquid;
c. one or more barriers that are each pivotally connected, at a first barrier end thereof, by a corresponding pivot to said base unit; and
d. a plurality of barrier restricting elements that are located on top of said base unit, each of said barrier restricting elements being suitable to restrict pivotal motion of one of said pivotally connected barriers in one rotational direction about said corresponding pivot upon contacting a second barrier end thereof,
wherein said corresponding pivot is located between one of said inlet and outlet ends and the turbine, and one of said barrier restricting elements for each of said barriers is located between one of said first and second walls and the turbine,
wherein one of said barriers is responsive to the flowing liquid introduced into said inlet end such that it pivots until the second barrier end thereof contacts the barrier restricting element located between the second wall and the turbine and becomes restricted, causing the introduced flowing liquid to become subdivided into first and second streams,
the first stream flowing uninhibitedly between said corresponding pivot of said one barrier and the first wall until impinging turbine blades at a first sector of the turbine to cause the turbine blades to rotate in a first rotational direction and to produce electrical energy,
the second stream being deflected by said one pivoted barrier and flowing along its length until exiting the second barrier end thereof and subsequently flowing along the second wall towards said outlet end, while being blocked from impinging the turbine blades at a second sector of the turbine that would cause the turbine blades to rotate, if impinged by the second stream, in a second rotational direction opposite to the first rotational direction, to prevent a counterflow effect on the turbine.

2. The system according to claim 1, further comprising a fin, which is connected to a bottom surface of the floatable base unit.

3. The system according to claim 2, wherein the fin comprises an inner space, suitable to contain inner components of the turbine.

4. The system according to claim 2, wherein the fin is detachable from the base unit.

5. The system according to claim 1, further comprising at least one net positioned at the inlet end or the outlet end of the base unit, suitable to prevent different objects from reaching the base unit.

6. The system according to claim 1, wherein the first and second walls are shaped to define flow directions the introduced liquid across the base unit.

7. The system according to claim 1, further comprising electricity conduction equipment.

8. The system according to claim 7, wherein the electricity conduction equipment is connected to a vessel.

9. The system according to claim 1, further comprising a capacitor suitable to store electrical energy that is produced by the turbine.

10. A method for efficiently converting wave energy into electricity, comprising:
a) providing an open-structured floatable base unit configured with opposite inlet and outlet ends defining a flow path therebetween along which liquid surrounding said base unit is able to flow after being introduced into said inlet end, and with opposite first and second walls extending between said inlet and outlet ends, for confining the flowing liquid therebetween;
b) operatively connecting a turbine on top of said base unit;
c) pivotally connecting each of one or more barriers, at a first barrier end thereof, by a corresponding pivot located between one of said inlet and outlet ends and the turbine, to an upper surface of said base unit;
d) fixing a plurality of barrier restricting elements to the upper surface of said base unit at a location between one of said first and second walls and the turbine;
e) immersing said base unit in a liquid body subjected to wave energy until it floats in the liquid body, in such a way that the liquid is caused to be introduced into said inlet end and that the turbine is ensured of being exposed to an upper surface of the introduced liquid; and
f) following introduction of the liquid into an interior of said base unit, one of said barriers pivots in one rotational direction in response to the flowing liquid introduced into said inlet end until the second barrier end thereof contacts the barrier restricting element located between the second wall and the turbine and its pivotal motion in said one rotational direction about said corresponding pivot becomes restricted, causing the introduced flowing liquid to become subdivided into first and second streams,
wherein the first stream flows uninhibitedly between said corresponding pivot of said one barrier and the first wall until impinging turbine blades at a first sector of the turbine to cause the turbine blades to rotate in a first rotational direction and to produce electrical energy,
wherein the second stream is deflected by said one pivoted barrier and flows along its length until exiting the second barrier end thereof and subsequently flows along the second wall towards said outlet end, while being blocked from impinging the turbine blades at a second sector of the turbine that would cause the turbine blades to rotate, if impinged by the second stream, in a second rotational direction opposite to the first rotational direction, to prevent a counterflow effect on the turbine.
